(19) United States
(12) Patent Application Publication
(10) Pub. No.: US 2024/0295452 A1
(43) Pub. Date: Sep. 5, 2024

(54) BLAST SENSOR WITH RELATED HOUSING

(71) Applicant: BlackBox Biometrics, Inc., Rochester, NY (US)

(72) Inventors: Vincent J. Baier, Beverly, MA (US); Logan Andrew McDermot, Marshall, WI (US); Casey Bolig, Rio, WI (US); Wayne Matthew Hansen, Lodi, WI (US)

(21) Appl. No.: 18/569,411

(22) PCT Filed: Jun. 24, 2022
(86) PCT No.: PCT/US2022/034949

§ 371 Date: Dec. 12, 2023

Related U.S. Application Data
(60) Provisional application No. 63/215,261, filed on Jun. 25, 2021.

(51) Int. Cl. G01L 5/14

(52) U.S. Cl. CPC G01L 5/14

(57) ABSTRACT

Systems and methods to positively retain an attachment cord to a housing of a blast sensor comprising top and bottom portions are disclosed. The top portion is coupled to the bottom portion in a closed configuration and at least partially separated from the bottom portion in an open configuration. The bottom portion of the housing comprises grooves at first and second ends configured to engage an attachment cord in the open configuration, and to positively retain the attachment cord to the housing of the blast sensor in the closed configuration.

### CLAIM OF PRIORITY

This application claims the benefit of priority under 35 U.S.C. § 119(e) of U.S. Provisional Patent Application Ser. No. 63/215,261, filed on Jun. 25, 2021, which is herein incorporated by reference in its entirety.

### BACKGROUND

Unwanted or excessive sound can have deleterious effects on human health. Sounds having sound pressure levels (SPLs) above 85 decibels (dB) for extended periods of time can damage structures of the inner ear, leading to noise-induced hearing loss (NIHL). The Occupational Safety and Health Administration (OSHA) requires the employers implement hearing conservation programs when noise exposure is at or above 85 decibels averaged over 8 working hours, or an 8-hour time-weighted average (TWA). Exposure to sound events at more than 105 dB average (dBA) can cause some amount of permanent hearing loss.

Exposure to impulse events, such as blast exposure, can produce high intensity overexposures, often referred to as blast overpressure (BOP), which can pose both a risk of NIHL and a risk of traumatic brain injury (TBI) with one or more cumulative exposures. Impulse events include impulse noise events, such as gunshots, explosions, or other sound events having fast initial rise times, such as 50 μs or less (e.g., frequencies of 20 kHz or higher), often with SPLs above 140 dB (depending on distance from the event).

Blast sensors can be configured to detect or monitor impulse noise or shock wave events and can be worn by a person to monitor impulse noise or shock wave event exposure of the person or attached to one or more objects (e.g., protective equipment, accessories, stationary objects, vehicles, etc.) to monitor impulse noise or shock wave event exposure to people or associated with or near the one or more objects.

### SUMMARY

Systems and methods to positively retain an attachment cord to a housing of a blast sensor comprising top and bottom portions are disclosed. The top portion is coupled to the bottom portion in a closed configuration and at least partially separated from the bottom portion in an open configuration. The bottom portion of the housing comprises grooves at first and second ends configured to engage an attachment cord in the open configuration, and to positively retain the attachment cord to the housing of the blast sensor in the closed configuration.

This summary is intended to provide an overview of subject matter of the present patent application. It is not intended to provide an exclusive or exhaustive explanation of the disclosure. The detailed description is included to provide further information about the present patent application. Other aspects of the disclosure will be apparent to persons skilled in the art upon reading and understanding the following detailed description and viewing the drawings that form a part thereof, each of which are not to be taken in a limiting sense.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1-3 illustrate an example prior art blast gauge.

FIGS. 4-7 illustrate an improved blast gauge housing with positive retention features.

FIG. 8 illustrates an example system including a dosimeter.

FIG. 9 illustrates a block diagram of an example machine upon which any one or more of the techniques (e.g., methodologies) discussed herein may perform.

### DETAILED DESCRIPTION

Blast sensors can include one or more stationary or ambulatory sensors (e.g., each including one or more pressure, acoustic, or other sensing element) configured to detect and monitor exposure to impulse noise or shock wave events. Most blast sensors, even stationary blast sensors, include a replaceable power source, such as a battery.

The present inventors have recognized, among other things, a positive retention device and method for secure attachment of a blast sensor to a variety of objects, positions, or locations (e.g., webbing, straps, rails, etc.) that reduces accidental detachment from prying forces and allows replacement of the replaceable power source without detachment.

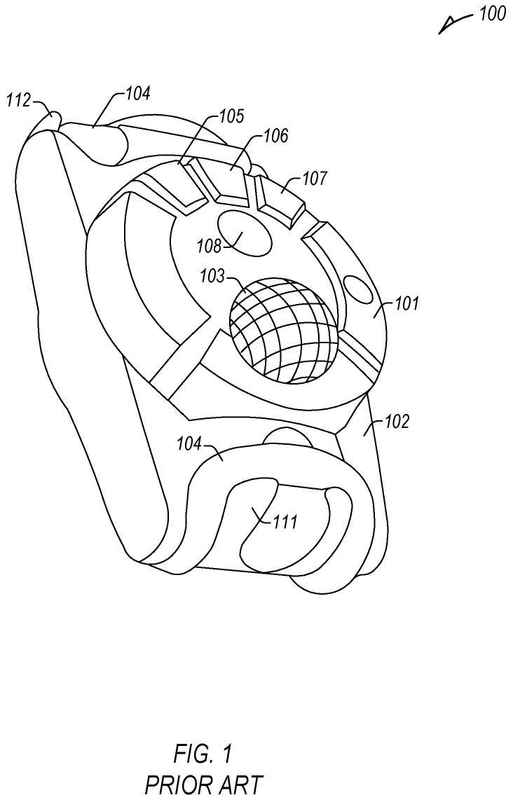

FIG. 1 illustrates a front perspective of an example prior art blast gauge 100 configured to detect impulse noise or shock wave events using a sensing element under a sensor dome 103 of mesh material at an upper surface 101 of a housing 102 of the blast gauge. The sensing element can include a pressure sensor, such as a silicon-based piezoresistive pressure sensor. The sensor dome 103 can be configured to reduce dirt and debris collection over the pressure sensor while still allowing detection of impulse noise or shock wave events by the sensing element.

The blast gauge 100 includes an attachment cord 104 (e.g., bungee, etc.) that engages mechanical features, including grooves 111 and protrusions 112, etc., at one or both ends of the housing 102. The blast gauge 100 additionally includes a button 108, and different first, second, and third indicators 105, 106, 107.

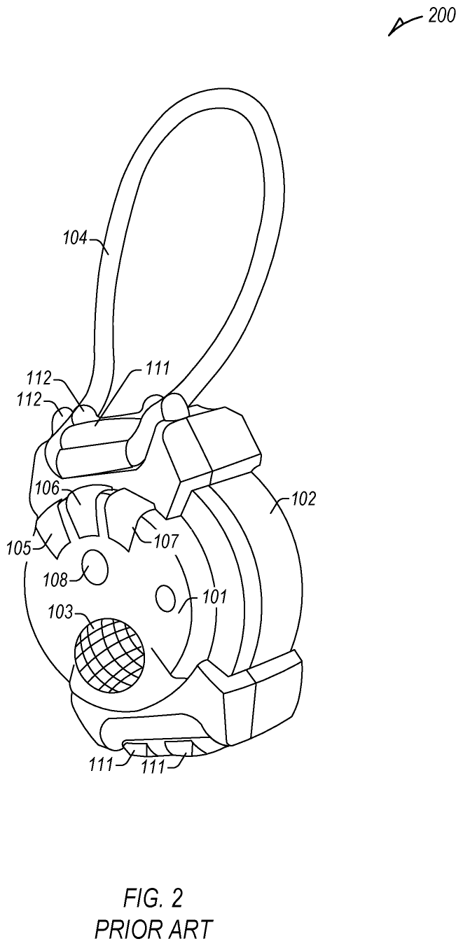

FIG. 2 illustrates a top perspectives of an example prior art blast gauge 200, such as that illustrated in FIG. 1. The attachment cord 104 is retained using a mechanical groove 111 and protrusions 112 at a first end of the housing 102. To position the blast gauge 200 a bottom of the housing is placed against an attachment surface or feature, and the attachment cord 104 is directed around the attachment surface or feature and secured to a groove 111 at a second end of the housing 102. The attachment cord 104 can be removed from mechanical groove 111 and protrusions 112 at the first end of the housing 102 for replacement, to attach cords of different lengths, etc.

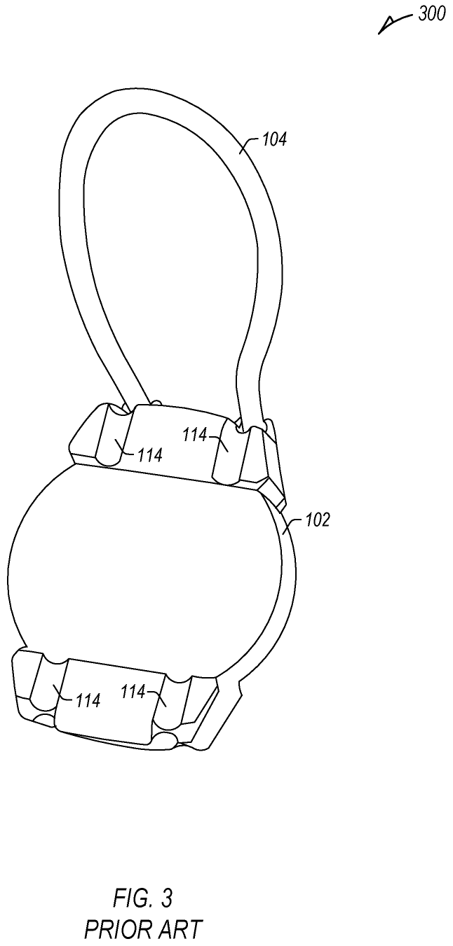

FIG. 3 illustrates a bottom perspective of an example prior art blast gauge 300, such as that illustrated in FIG. 1. The bottom of the housing 102 includes channels 114 to more securely attach the attachment cord 104 around attachment features, such as straps, etc.

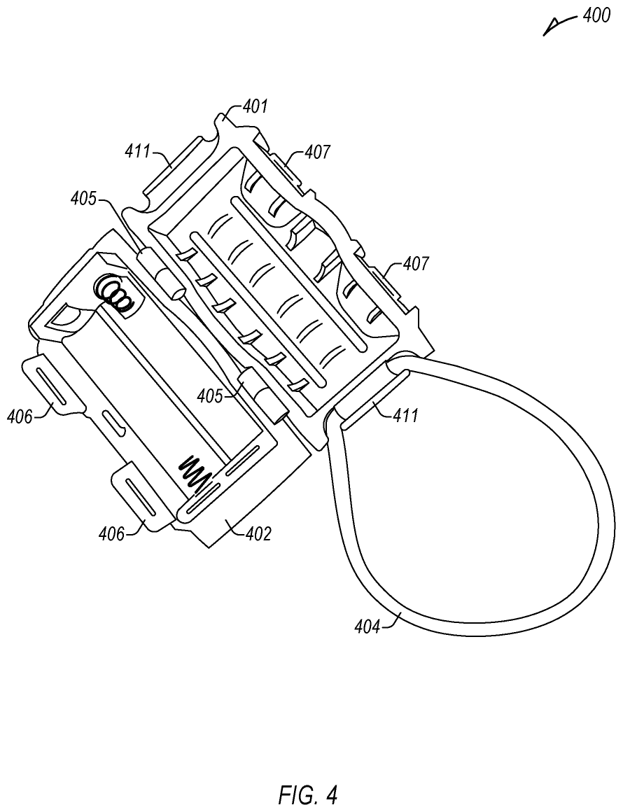

FIG. 4 illustrates an example improved blast gauge housing 400 with positive retention features, including a mechanical groove 411 at first and second ends of a first housing portion 401 configured to engage an attachment cord 404 while the first housing portion 401 is separate from a corresponding second housing portion 402, in an open configuration, but that secures the attachment cord 404 in the mechanical groove 411 when the second housing portion 402 is closed over the first housing portion 401.

The improved blast gauge housing 400 can have a split-shell configuration with separate first and second portions 401, 402 (e.g., top and bottom portions, etc.). One or both of the first and second portions 401, 402 can include a groove 411 at first and second ends configured to engage an attachment cord 404. The attachment cord 404 can be placed into or removed from the grooves 411 when the first and second portions 401, 402 are in an open configuration. When the first and second portions 401, 402 are in a closed configuration, the attachment cord 404 is secured in the grooves 411, maintaining positive retention of the attachment cord 404 and the improved blast gauge housing to any engaged attachment surface or feature while the integrity of the attachment cord remains, or until the first and second portions 401, 402 are transitioned to an open configuration. Even in the open configuration, the improved blast gauge housing 400 retains the attachment features of the prior art blast gauges.

In an example, the first portion 401 is coupled to the second portion 402 at one side by a hinge 405 or other mechanical mechanism configured to retain connection between the first and second portions 401, 402 when open, and is configured to engage a second opposite second side using one or more mechanical engagement features, such as male and female mating joints, cantilever hook, snap fit components, etc. In other examples, the second portion 402 can be coupled to the first portion 401 at multiple sides using one or more mechanical features (with or without hinges or other retention features), or can be secured once coupled in a closed configuration using a clasp, latch, or other mechanical locking mechanism. In an example, the first portion 401 can include keepers 407 and a second portion 402 can include corresponding latches 406 configured to engage the keepers 407 to secure the first portion 401 to the second portion 402.

The split-shell configuration allows for replacement of a replaceable power source (e.g., replaceable batteries) in the open configuration without removing the attachment cord or re-securing the improved blast gauge housing to a previously engaged attachment surface or feature. In addition, the hinge 405 or other mechanical mechanism configured to retain connection between the first and second portions 401, 402 when open can reduce accidental loss of parts of the blast housing gauge 400. It certain examples it can be advantageous to secure electronics and batteries to the second portion 402 when in an open configuration, such as to ease replacement of a malfunctioning sensor without having to detach the first portion 401 from the existing attachment point.

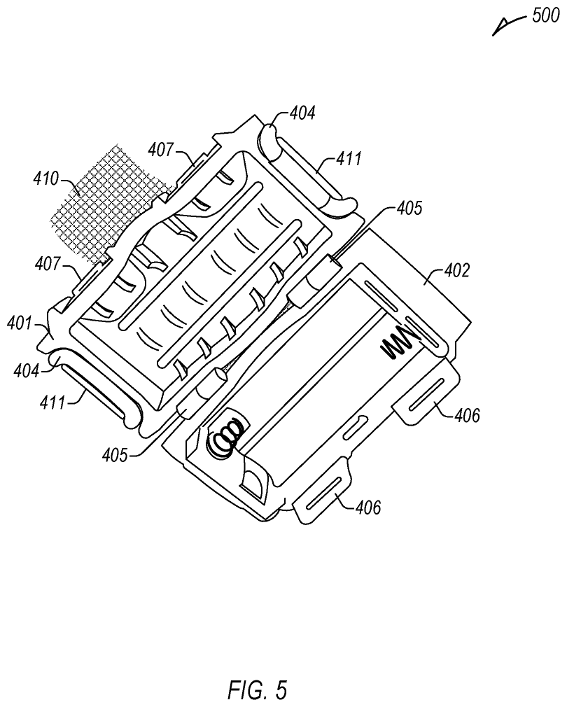

FIGS. 5-7 illustrate example improved blast gauge housings 500, 600, 700 attached to an attachment feature 410, such as a strap, a belt, a belt loop, or one or more other attachment features, etc., in open and closed configurations.

FIG. 5 illustrates a top view of the blast gauge housing 500 in an open configuration where an attachment cord 404 is engaged in grooves 411 at first and second ends of a first portion 401 of the blast gauge housing 500, but not secured. In the open configuration, the attachment cord 404 can be lifted out of the grooves 411 to detach the blast gauge housing 500 from the attachment feature 410.

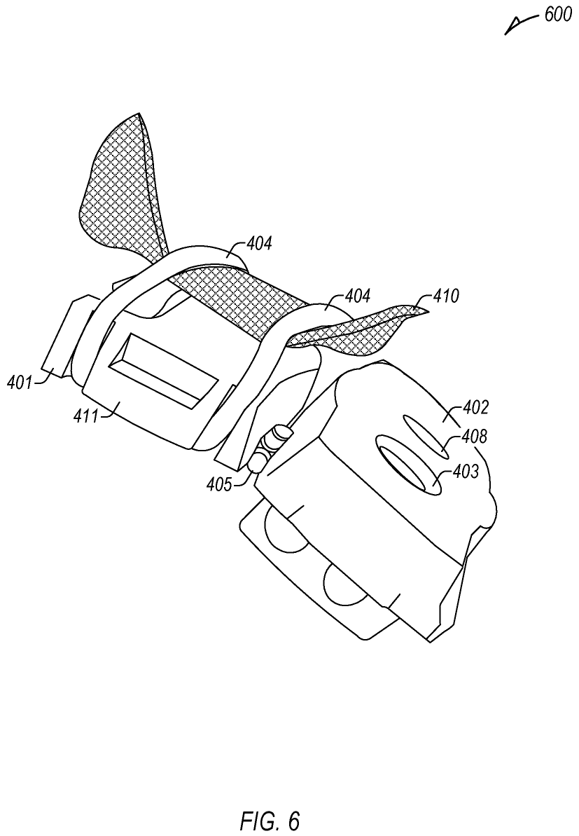

FIG. 6 illustrates a bottom view of the blast gauge housing 600, including an attachment of the attachment cord 404 to the attachment feature 410, such as a nylon strap, etc. The blast gauge housing 600 additionally illustrates an opening configured to contain a pressure sensor or one or more other sensing elements configured to detect impulse noise or shock wave events. The blast gauge housing 600 can additionally include one or more buttons 408 for operation or indicators to provide visual indicators of operation or exposure, etc.

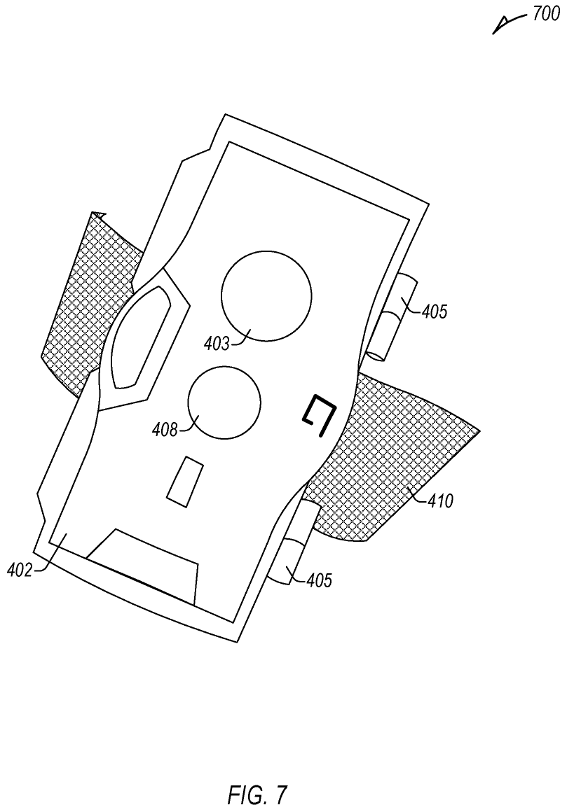

FIG. 7 illustrates a top view of the blast gauge housing 700 in closed configuration. In contrast to that illustrated in FIG. 5, where the attachment cord 404 is engaged but not secured, in FIG. 7, the attachment cord 404 is secured in grooves 411 by closing the second portion 402 over the first portion 401 of the blast gauge housing 700, trapping the attachment cord 404 in the grooves 411, holding it in place until the second portion 402 is moved from the closed configuration to an open configuration.

In certain examples, the grooves 411 can be configured such that the attachment cord 404 is not even visible from the top view. In this example, the likelihood of the attachment cord 404 being sheered or snagged is reduced, such as in contrast to the configuration illustrated in FIGS. 1-3. In certain examples, the blast gauge housing 700 is securely fixed to the attachment feature 410, and will remain so until the blast gauge housing 700 is opened, the attachment cord 404 is cut, or the attachment feature 410 breaks or is severed, providing substantial benefit to the configuration illustrated and described in FIGS. 1-3.

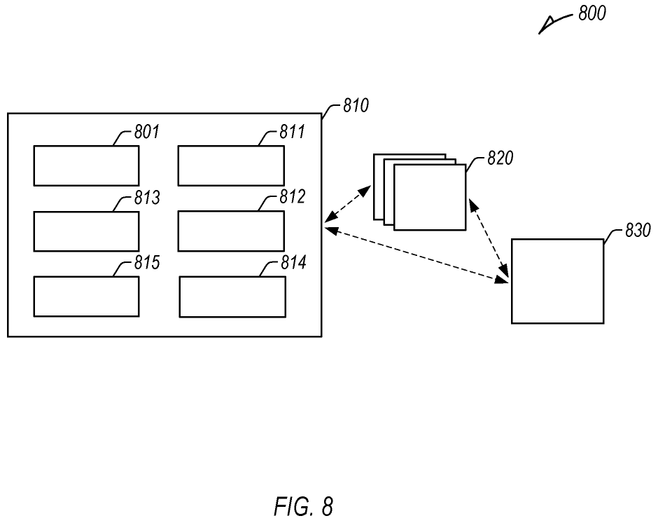

FIG. 8 illustrates an example system 800 including a dosimeter 810. The dosimeter 810 can include a blast sensor 801, such as one or more of the previous blast sensors or pressure sensors disclosed and described herein and additional components configured to enable the blast sensor 801 to operate as a networked or stand-alone dosimeter device. The dosimeter 810 can include a dosimeter circuit 811 (or one or more other processors or control circuits) configured to receive information from the blast sensor 801 (e.g., a pressure sensor, etc.) and to measure or monitor exposure to time-aggregate impulse noise or shock wave events, determine the magnitude of and count individual events, etc. The dosimeter 810 can include a telemetry circuit 812 configured to provide communication (wired or wireless) into or out of the dosimeter 810 according to one or more communication protocols. In certain examples, the telemetry circuit 812 can be configured for one or both of wired and wireless communication, in certain examples, separately selectable by a user, etc.

In an example, the dosimeter 810 can include a housing (e.g., a wearable housing configured to be worn by a user, a non-wearable housing configured to be fixed to a specific location, etc.) configured to house the blast sensor 801, the dosimeter circuit 811, the telemetry circuit 812, and a power source 813 configured to provide power to the system 800. In certain examples, the dosimeter 810 can include one or more audible or visual indicators 814 configured to provide one or more indications to a user (e.g., lights, speakers, a display screen, etc.), and one or more inputs 815 (e.g., button interfaces, a touch-screen interface, etc.) configured to receive user input, commands, etc. In certain examples, the dosimeter 810 can include one or more elastic cords or other physical attachments to enable secure attachment to the body or one or more other pieces of equipment, etc.

In an example, the power source 813 can include a rechargeable battery. In other examples, the power source 813 can specifically include a non-rechargeable battery configured to provide power for the components of the dosimeter 810 for a substantial time period, such as up to 1-year or more, and the remaining components of the dosimeter 810 can be configured for such long-term use (e.g., wired telemetry, etc.). In an example, the power source 813 can be a replaceable battery, rechargeable or non-rechargeable.

In an example, the dosimeter circuit 811 can include an ADC, or one or more amplifiers, pre-amplifiers, filter circuits, etc., configured to process an attenuated output signal from the blast sensor 801. The dosimeter circuit 811 can be configured to detect and record event information, such as impulse noise or shock wave event signatures in real time. The dosimeter circuit 811 can be configured to distinguish between shock wave (e.g., blast overpressure (BOP)) and other impulse events, such as by using a detected rise time, frequency, event signature, etc., and separately account for such event types, and distinguish separate harms to the user, including between NIHL and TBI, etc. In addition, the dosimeter circuit 811 can be configured to identify and reject mechanical impulse or mechanical shock events, such as due to motion or physical touching or contact of the dosimeter 810, separate from an impulse noise or shock wave events, using signal characteristics, such as rise time, frequency, event signature, etc.

In addition, the dosimeter circuit 811 can be configured to measure or determine exposure to adverse impulse noise or shock wave events over various time periods, such as over a 24-hour period, an 8-hour period, or longer or shorter time periods, to avoid deleterious effects to a user exposed to such adverse events. In an example, using information from the dosimeter circuit 811 or information received from one or more other control circuits or processors, such as through the telemetry circuit 812, the one or more audible or visual indicators 814 can be configured to alert a user that one more harmful exposure levels is approaching or has been exceeded. In other examples, the one or more audible or visual indicators 814 can notify a user that no harmful events or levels have been detected or exceeded.

In certain examples, the dosimeter 810 can include one or more location sensors, such as GPS, cellular, or other location-based sensors. The dosimeter 810 can further include one or more other atmospheric or environmental sensors (e.g., temperature, atmospheric pressure, etc.). In certain examples, the dosimeter circuit 811 can be configured to adjust the measurement or monitoring of impulse noise or shock wave events or exposure using the received atmospheric or environmental information. In certain examples, the dosimeter circuit 811 can include a clock and can be configured to store a log of timestamped events, such as having SPLs above a certain level, specific signatures, etc.

In an example, the system 800 can include one or more additional dosimeters 820, including one or more components illustrated in the dosimeter 810, additional sensors, etc., or one or more additional stationary housings, sensors, or sensor systems. The system 800 can further include a central processing device 830 including one or more circuits or processors configured to provide information to or receive information from one or multiple sensors, such as one or more sensors associated with a single user, sensors associated with multiple users, one or more stationary sensors, or combinations thereof. The central processing device 830 can store information from the dosimeter 810 or the one or more additional dosimeters 820 or stationary housings, sensors, or sensor systems. In an example, the central processing device 830 can include a portable or non-portable computer hub, such as a tablet or a personal computer, configured to collect data from one or more sensors, dosimeters, etc., and store information for analysis, such as with respect to one or more sensors, dosimeters, users, groups of users, geographic area, etc., in a database.

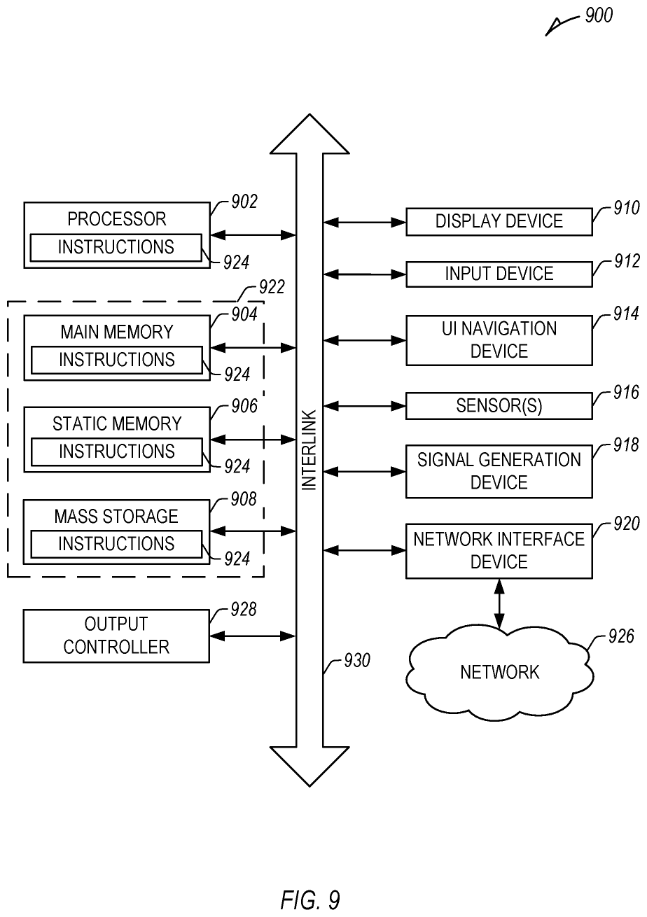

FIG. 9 illustrates a block diagram of an example machine 900 upon which any one or more of the techniques (e.g., methodologies) discussed herein may perform. Portions of this description may apply to the computing framework of one or more of the dosimeters, circuits, or processors described herein. Examples, as described herein, may include, or may operate by, logic or a number of components, or mechanisms in the machine 900. Circuitry (e.g., processing circuitry, a dosimeter circuit, etc.) is a collection of circuits implemented in tangible entities of the machine 900 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 900 follow.

In alternative embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 900 may include a hardware processor 902 (e.g., a central processing unit (CPU), a graphics processing unit (GPU), a hardware processor core, or any combination thereof), a main memory 904, a static memory (e.g., memory or storage for firmware, microcode, a basic-input-output (BIOS), unified extensible firmware interface (UEFI), etc.) 906, and mass storage 908 (e.g., hard drive, tape drive, flash storage, or other block devices) some or all of which may communicate with each other via an interlink (e.g., bus) 930. The machine 900 may further include a display unit 910, an alphanumeric input device 912 (e.g., a keyboard), and a user interface (UI) navigation device 914 (e.g., a mouse). In an example, the display unit 910, input device 912, and UI navigation device 914 may be a touch screen display. The machine 900 may additionally include a signal generation device 918 (e.g., a speaker), a network interface device 920, and one or more sensors 916, such as a global positioning system (GPS) sensor, compass, accelerometer, or one or more other sensors. The machine 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 902, the main memory 904, the static memory 906, or the mass storage 908 may be, or include, a machine-readable medium 922 on which is stored one or more sets of data structures or instructions 924 (e.g., software) embodying or utilized by any one or more of the techniques or functions described herein. The instructions 924 may also reside, completely or at least partially, within any of registers of the processor 902, the main memory 904, the static memory 906, or the mass storage 908 during execution thereof by the machine 900. In an example, one or any combination of the hardware processor 902, the main memory 904, the static memory 906, or the mass storage 908 may constitute the machine-readable medium 922. While the machine-readable medium 922 is illustrated as a single medium, the term “machine-readable medium” may include a single medium or multiple media (e.g., a centralized or distributed database, and/or associated caches and servers) configured to store the one or more instructions 924.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine-readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may be further transmitted or received over a communications network 926 using a transmission medium via the network interface device 920 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900, and includes digital or analog communications signals or other intangible medium to facilitate communication of such software. A transmission medium is a machine-readable medium.

Various embodiments are illustrated in the figures above. One or more features from one or more of these embodiments may be combined to form other embodiments. Method examples described herein can be machine or computer-implemented at least in part. Some examples may include a computer-readable medium or machine-readable medium encoded with instructions operable to configure an electronic device or system to perform methods as described in the above examples. An implementation of such methods can include code, such as microcode, assembly language code, a higher-level language code, or the like. Such code can include computer readable instructions for performing various methods. The code can form portions of computer program products. Further, the code can be tangibly stored on one or more volatile or non-volatile computer-readable media during execution or at other times.

Example 1 is a blast sensor system, comprising: a housing comprising a top portion and a bottom portion, wherein the top portion is coupled to the bottom portion in a closed configuration and at least partially separated from the bottom portion in an open configuration, wherein the bottom portion of the housing comprises grooves at first and second ends configured to engage an attachment cord in the open configuration, and wherein the housing is configured to positively retain the attachment cord in the closed configuration.

In Example 2, the subject matter of Example 1 includes, wherein the top portion includes a first mechanical feature configured to mechanically engage a second mechanical feature of the bottom portion in the closed configuration.

In Example 3, the subject matter of Example 2 includes, wherein the attachment cord is configured to attach the bottom portion of the housing to an attachment feature.

In Example 4, the subject matter of Example 3 includes, wherein the top portion of the housing is configured to disengage from the bottom portion of the housing for replacement when the blast sensor system is in the open configuration, without the attachment cord detaching from the attachment feature.

In Example 5, the subject matter of Examples 2-4 includes, a hinge configured to movably affix a first side of the top portion of the housing to a first side of the bottom portion of the housing, wherein the first and second mechanical features are located on a second side of the top and bottom portions of the housing opposite the first side.

In Example 6, the subject matter of Example 5 includes, wherein the attachment cord is configured to attach the bottom portion of the housing to an attachment feature, and wherein the top portion of the housing is configured to disengage from the bottom portion of the housing at the hinge for replacement when the blast sensor system is in the open configuration, without the attachment cord detaching from the attachment feature.

In Example 7, the subject matter of Examples 1-6 includes, a blast sensor proximate an upper surface of the top portion of the housing configured to detect or monitor impulse noise or shock wave events at the upper surface.

In Example 8, the subject matter of Examples 1-7 includes, wherein the grooves in the bottom portion are configured to retain the attachment cord within a footprint of the top portion of the housing in the closed configuration.

In Example 9, the subject matter of Examples 1-8 includes, wherein the top portion of the housing is configured to contain electronics of the blast sensor system and to engage and retain a replaceable battery of the blast sensor system.

Example 10 is a method, comprising: engaging an attachment cord to a bottom portion of a housing of a blast sensor system using grooves at first and second ends of the bottom portion of the housing in an open configuration; and positively retaining the attachment cord to the housing of the blast sensor system using a top portion of the housing and the bottom portion of the housing in a closed configuration, wherein the top portion is coupled to the bottom portion in the closed configuration and at least partially separated from the bottom portion in the open configuration.

In Example 11, the subject matter of Example 10 includes, mechanically engaging, using a first mechanical feature of the top portion of the housing, a second mechanical feature of the bottom portion in the closed configuration.

In Example 12, the subject matter of Example 11 includes, attaching the bottom portion of the housing to an attachment feature using the attachment cord.

In Example 13, the subject matter of Example 12 includes, disengaging the top portion of the housing from the bottom portion of the housing for replacement in the open configuration, without the attachment cord detaching from the attachment feature.

In Example 14, the subject matter of Examples 11-13 includes, movably affixing a first side of the top portion of the housing to a first side of the bottom portion of the housing using a hinge, wherein the first and second mechanical features are located on a second side of the top and bottom portions of the housing opposite the first side.

In Example 15, the subject matter of Example 14 includes, attaching the bottom portion of the housing to an attachment feature, and disengaging the top portion of the housing from the bottom portion of the housing at the hinge for replacement when the blast sensor system is in the open configuration, without the attachment cord detaching from the attachment feature.

In Example 16, the subject matter of Examples 10-15 includes, detecting or monitoring impulse noise or shock wave events at the upper surface using a blast sensor proximate an upper surface of the top portion of the housing.

In Example 17, the subject matter of Examples 10-16 includes, retaining the attachment cord within a footprint of the top portion of the housing using the grooves in the bottom portion of the housing.

In Example 18, the subject matter of Examples 10-17 includes, retaining electronics of the blast sensor system and engaging and retaining a replaceable battery of the blast sensor system in the top portion of the housing in the open configuration.

Example 19 is a blast sensor system, comprising: means for engaging an attachment cord to a bottom portion of a housing of a blast sensor system in an open configuration; and means for positively retaining the attachment cord to the housing of the blast sensor system in a closed configuration, wherein the top portion is coupled to the bottom portion in the closed configuration and at least partially separated from the bottom portion in the open configuration.

In Example 20, the subject matter of Example 19 includes, means for movably affixing a first side of the top portion of the housing to a first side of the bottom portion of the housing, means for attaching the bottom portion of the housing to an attachment feature, and means for disengaging the top portion of the housing from the bottom portion of the housing for replacement when the blast sensor system is in the open configuration, without the attachment cord detaching from the attachment feature.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

The above detailed description is intended to be illustrative, and not restrictive. The scope of the disclosure should, therefore, be determined with references to the appended claims, along with the full scope of equivalents to which such claims are entitled.

What is claimed is:

1. A blast sensor system, comprising:
a housing comprising a top portion and a bottom portion, wherein the top portion is coupled to the bottom portion in a closed configuration and at least partially separated from the bottom portion in an open configuration,
wherein the bottom portion of the housing comprises grooves at first and second ends configured to engage an attachment cord in the open configuration, and
wherein the housing is configured to positively retain the attachment cord in the closed configuration.

2. The blast sensor system of claim 1, wherein the top portion includes a first mechanical feature configured to mechanically engage a second mechanical feature of the bottom portion in the closed configuration.

3. The blast sensor system of claim 2, wherein the attachment cord is configured to attach the bottom portion of the housing to an attachment feature.

4. The blast sensor system of claim 3, wherein the top portion of the housing is configured to disengage from the bottom portion of the housing for replacement when the blast sensor system is in the open configuration, without the attachment cord detaching from the attachment feature.

5. The blast sensor system of claim 2, including a hinge configured to movably affix a first side of the top portion of the housing to a first side of the bottom portion of the housing,
wherein the first and second mechanical features are located on a second side of the top and bottom portions of the housing opposite the first side.

6. The blast sensor system of claim 5, wherein the attachment cord is configured to attach the bottom portion of the housing to an attachment feature, and
wherein the top portion of the housing is configured to disengage from the bottom portion of the housing at the hinge for replacement when the blast sensor system is in the open configuration, without the attachment cord detaching from the attachment feature.

7. The blast sensor system of claim 1, including a blast sensor proximate an upper surface of the top portion of the housing configured to detect or monitor impulse noise or shock wave events at the upper surface.

8. The blast sensor system of claim 1, wherein the grooves in the bottom portion are configured to retain the attachment cord within a footprint of the top portion of the housing in the closed configuration.

9. The blast sensor system of claim 1, wherein the top portion of the housing is configured to contain electronics of the blast sensor system and to engage and retain a replaceable battery of the blast sensor system.

10. A method, comprising:
engaging an attachment cord to a bottom portion of a housing of a blast sensor system using grooves at first and second ends of the bottom portion of the housing in an open configuration; and
positively retaining the attachment cord to the housing of the blast sensor system using a top portion of the housing and the bottom portion of the housing in a closed configuration,
wherein the top portion is coupled to the bottom portion in the closed configuration and at least partially separated from the bottom portion in the open configuration.

11. The method of claim 10, comprising:
mechanically engaging, using a first mechanical feature of the top portion of the housing, a second mechanical feature of the bottom portion in the closed configuration.

12. The method of claim 11, comprising:
attaching the bottom portion of the housing to an attachment feature using the attachment cord.

13. The method of claim 12, comprising:
disengaging the top portion of the housing from the bottom portion of the housing for replacement in the open configuration, without the attachment cord detaching from the attachment feature.

14. The method of claim 11, comprising:
movably affixing a first side of the top portion of the housing to a first side of the bottom portion of the housing using a hinge,
wherein the first and second mechanical features are located on a second side of the top and bottom portions of the housing opposite the first side.

15. The method of claim 14, comprising:
attaching the bottom portion of the housing to an attachment feature, and
disengaging the top portion of the housing from the bottom portion of the housing at the hinge for replacement when the blast sensor system is in the open configuration, without the attachment cord detaching from the attachment feature.

16. The method of claim 10, comprising
detecting or monitoring impulse noise or shock wave events at an upper surface of the top portion of the housing using a blast sensor proximate the upper surface.

17. The method of claim 10, comprising:
retaining the attachment cord within a footprint of the top portion of the housing using the grooves in the bottom portion of the housing.

18. The method of claim 10, comprising:
retaining electronics of the blast sensor system and engaging and retaining a replaceable battery of the blast sensor system in the top portion of the housing in the open configuration.

19. A blast sensor system, comprising:
means for engaging an attachment cord to a bottom portion of a housing of a blast sensor system in an open configuration; and
means for positively retaining the attachment cord to the housing of the blast sensor system in a closed configuration,
means for coupling a top portion of the housing to the bottom portion in the closed configuration and at least partially separating the top portion from the bottom portion in the open configuration.

20. The system of claim 19, comprising:
means for attaching the bottom portion of the housing to an attachment feature, and
wherein the means for coupling the top portion of the housing to the bottom portion in the closed configuration and at least partially separating the top portion from the bottom portion in the open configuration include means for:
movably affixing a first side of the top portion of the housing to a first side of the bottom portion of the housing; and
disengaging the top portion of the housing from the bottom portion of the housing for replacement when the blast sensor system is in the open configuration, without the attachment cord detaching from the attachment feature.
